(19) United States
(12) Patent Application Publication
(10) Pub. No.: US 2008/0090167 A1
(43) Pub. Date: Apr. 17, 2008

(54) Method of addition of extra particulate additives to image forming material

(76) Inventors: Ligia Aura Bejat, Versailles, KY (US); John Earley, Boulder, CO (US); Rick Owen Jones, Berthoud, CO (US); George Pharris Marshall, Denver, CO (US); John Melvin Olson, Boulder, CO (US); Trent Peter, Johnstown, CO (US); Minerva Piffarerio, Erie, CO (US); Vincent Wen-Hwa Ting, Boulder, CO (US); Ronald James Whildin, Boulder, CO (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/549,251

(22) Filed: Oct. 13, 2006

(51) Int. Cl. G03G 9/08

(52) U.S. Cl. 430/137.1

(57) ABSTRACT

The present invention relates to a method for combining extra particulate additive with toner. The method includes mixing toner and extra particulate additive in a conical mixer having temperature control. The toner may contain polymeric material having a glass transition temperature (Tg) and the mixing may be carried out wherein the temperature of the mixture is maintained at a temperature less than Tg. The above method may also be applied to a toner formulation that has first undergone a rounding operation.

### CROSS REFERENCES TO RELATED APPLICATIONS

This patent application is related to the U.S. patent application Ser. No. ______, filed MONTH DAY, 2006, entitled “ADDITION OF EXTRA PARTICULATE ADDITIVES TO CHEMICALLY PROCESSED TONER” and assigned to the assignee of the present application.

### STATEMENT REGARDING FEDERALLY SPONSORED RESEARCH OR DEVELOPMENT

None.

### REFERENCE TO SEQUENTIAL LISTING, ETC.

None.

### FIELD OF INVENTION

The present invention relates to a method of adding an extra particulate additive to an image forming material used in an image forming apparatus. The extra particulate additive may be blended with the toner under controlled conditions, where the temperature of the toner may be monitored and controlled. An image forming apparatus may include printers, electrophotographic printers, copiers, faxes, all-in-one devices or multi-functional devices.

### BACKGROUND

Toner particles may be formed by the process of compounding a polymeric resin, with colorants and optionally other additives. These ingredients may be blended through, for example, melt mixing. The resultant materials may then be ground and classified by size to form a powder. Toner compositions so formed may be used in electrophotographic printers and copiers, such as laser printers wherein an image may be formed via use of a latent electrostatic image which is then developed to form a visible image on a drum which may then be transferred onto a suitable substrate.

### SUMMARY

In a first exemplary embodiment, the present invention relates to a method for combining extra particulate additive with toner. The method may include mixing toner and extra particulate additive to form a mixture in a conical mixer. The toner may comprise polymeric material having a glass transition temperature (Tg) and the mixing may be carried out wherein the mixture is maintained at a temperature less than Tg. Such temperature control may be facilitated by controlling the temperature of the mixing device and/or the temperature of an internal temperature probe.

In a second exemplary embodiment, the present invention relates to another method for combining extra particulate additive with toner. The method includes mixing in a conical mixer toner and extra particulate additive to form a mixture, wherein the toner comprises polymer material having a glass transition temperature (Tg) and mixing is carried out wherein the mixture is raised to a temperature that is equal to or exceeds the Tg (i.e. ≧Tg). This may then be followed by adding additional extra particulate additive and mixing wherein the mixture is maintained at a temperature less than Tg. Such temperature control may again be facilitated by controlling the temperature of the mixing device and/or the temperature of an internal temperature probe.

### DETAILED DESCRIPTION

The present invention relates to a method of adding extra particulate additives to image forming substances such as toner. The image forming substance may be used in, for example, electrophotographic printers, inkjet printers, copiers, faxes, all-in-one devices or multi-functional devices.

The toner particles herein may be prepared by conventional methods (e.g. a pulverization process). In a conventional method, a binder (e.g. polymer) resin, a colorant, a charge control agent and additives such as a release agent may be combined, mixed and melt-kneaded, followed by cooling and pulverization. This may then be followed by classification to a desired particle size distribution. In addition, pulverization may be carried out by a grinding machine, such as an impact jet mill. However, the shape of the toner particles obtained by such pulverization may lack a definite form.

The various pigments which may be included include pigments for producing cyan, black, yellow or magenta toner particle colors. The pigments themselves may range in particle size between 10 nm and 2 μm, including all values and increments therebetween. The pigments may be included within a range of about 2 to 12% by weight. Additional additives may also be incorporated into the toner particles such as charge control agents and release agents.

The present invention operates to provide a finishing to toner particles, as more specifically described below. Such finishing may rely upon what may be described as a device of mixing, cooling and/or heating the particles which is available from Hosokawa Micron BV and is sold under the trade name “CYCLOMIX®.” Such device may be understood as a conical device having a cover part and a vertical axis which device narrows in a downward direction. The device may include a rotor attached to a mixing paddle that may also be conical in shape and may include a series of spaced, increasingly wider blades extending to the inside surface of the cone that may serve to agitate the contents as they are rotated. Shear may be generated at the region between the edge of the blades and the device wall. Centrifugal forces may therefore urge product towards the device wall and the shape of the device may then urge an upward movement of product. The cover part may then urge the products toward the center and then downward, thereby providing a feature of recirculation.

The device as a mechanically sealed device may operate without an active air stream, and may therefore define a closed system. Such closed system may therefore provide relatively vigorous mixing and the device may also be configured with a heating/cooling jacket, which allows for the contents to be heated in a controlled manner, and in particular, temperature control at that location between the edge of the blades and the device wall. The device may also include an internal temperature probe so that the actual temperature of the contents can be monitored. An exemplary conical mixing device is described in U.S. Pat. No. 6,599,005 whose teachings are incorporated by reference.

In a first exemplary toner finishing operation the toner particles may be combined with extra particulate additive (EPA). The extra particulate additive(s) may serve a variety of functions, such as to modify or moderate toner charge, increase toner abrasive properties, influence the ability/tendency of the toner to deposit on surfaces, improve toner cohesion, or eliminate moisture-induced tribo-excursions. The extra particulate additives may therefore be understood to be a solid particle of any particular shape. Such particles may be of micron or submicron size and may have a relatively high surface area. The extra particulate additives may be organic or inorganic in nature. For example, the additives may include a mixture of two inorganic materials of different particle size, such as a mixture of differently sized fumed silica. The relatively small sized particles may provide a cohesive ability, e.g. the ability to improve powder flow of the toner. The relatively larger sized particles may provide the ability to reduce relatively high shear contact events during the image forming process, such as undesirable toner deposition (filming).

The fumed silica contemplated herein may be sourced from Degussa Corporation, under the trademark Aerosil® and may include, for example, the product grades RY50, A380, NY50 or R812. In addition the silica particles may be surface treated with silicone oil. The particles may have a negative electrostatic charge in the range of −400 to −600 μC/g, including all values and increments therein, and a specific surface area of between about 10-50 m²/g, including all values and increments therein. The inorganic additives may also include oxides, such as fumed oxides or precipitated oxides. For example, silica, titania and other oxides may be utilized. The extra particulate additives may be added up to 5.0% by weight (wt.) within a given toner formulation, including all values and increments therein. For example, the extra particulate additive may be added up to about 2.5% (wt.).

The extra particulate additives herein may also be acicular in structure having a length of between about 1 to 10 microns and any increment or value therein and a diameter of between about 0.01 to 100 microns and any increment or value therein. Acicular may be understood as a general reference to a shape wherein one dimension (e.g., length) exceeds another dimension (e.g., width). The particles may specifically include metal particles or metal oxide particles, such as titanium dioxide. The particles may also be surface treated. For example, the acicular particles may be treated with silicon oxide and/or one or more metal oxides, including for example aluminum oxide, cerium oxide, iron oxide, zirconium oxide, lanthanum oxide, tin oxide, antimony oxide, indium oxide, etc. One particular exemplary particle includes acicular titanium dioxide particles surface treated with aluminum oxide, which may be obtained from Ishihara Corporation, USA. The acicular particles may also be treated with one or more organic reagents, such as a functional organic reagent to modify hydrophobic or hydrophilic surface characteristics.

For example, conventional toner, which as alluded to above may be understood as toner sourced from a mechanical pulverization/grinding technique, may be first combined with one or more extra particulate additives and placed within the above referenced conical mixing vessel. The temperature of the vessel may then be controlled such that the toner polymer resins are not exposed to a corresponding glass transition temperature or Tg which could lead to some undesirable adhesion between the polymer resins prior to mixing and/or coating with the EPA material. Accordingly, the heating/cooling jacket may be set to a temperature of less than or equal to the Tg of the polymer resins in the toner, and preferably to a cooling temperature of less than or equal to about 25° C. In addition, it may be convenient to rely upon the use of an internal temperature probe that may be set so that the contents do not exceed a given Tg, or in a particular embodiment, a temperature of less than or equal to about 25° C. It should also be understood herein that Tg may be identified by a differential scanning calorimetry (DSC) scan wherein the Tg may be recorded as either the departure from the baseline in the DSC thermogram (Tgₒₙₛₑₜ) or the midpoint of the identified and measured change in heat capacity (Tg_{midpoint}) at a heating rate of less than or equal to about 10° C. per minute.

Expanding upon the above, it can now be appreciated that for a given polymer resin and a given Tg that may be associated with such resin, the heating/cooling jacket and/or the internal temperature probe may be set to a temperature that is at least about 5° C. or more below such Tg, including all values and increments therein. For example, the heating/cooling jacket and/or internal temperature probe may be set to a temperature that is 10° C. below Tg, or a temperature that is between about 10-100° C. below Tg. Furthermore, it may also be appreciated that in the case of a toner that may include more than one polymer resin, one may identify the lowest Tg of any such mixture of resins. Accordingly, one then may proceed as noted above, and control the heating/cooling jacket and/or the internal temperature probe with respect to such identified Tg value. It should also be understood that with respect to a mixture of polymer resins, the resins may have about the same Tg value, in which case the lowest relative Tg may be the same within the mixture.

The conical mixing device with such temperature control may then be operated wherein the rotor of the mixing device may preferably be configured to mix in a multiple stage sequence, wherein each stage may be defined by a selected rotor rpm value (RPM) and time (T). Such multiple stage sequence may be particularly useful in the event that one may desire to provide some initial break-up of toner agglomerates. For example, the rotor may be initially operated to mix at a value of less than or equal to about 500 rpm, including all values and increments therein. More specifically, the rotor may be operated at a value of between about 300-400 rpm, or at a value of about 300-350 rpm, or at a value of about 325 rpm. In addition, such initial first stage of mixing may be controlled in time, such that the conical mixer operates at such rpm values for a period of less than or equal to about 60 seconds, including all values and increments therein. Then, in a second stage of mixing, the rpm value may be set higher than the rpm value of the first stage, e.g., at an rpm value greater than about 500 rpm. For example, the rotor may be operated in a second stage at an rpm value of about 750-2000 rpm, including all values and increments therein. Preferably, the rpm value in the second stage of mixing may be about 1000-1500 rpm, or even 1300-1400 rpm. Furthermore, the time for mixing in the second stage may be greater than about 60 seconds, and more preferably, about 60-180 seconds, including all values and increments therein. For example, the second stage may therefore include mixing at a value of about 1300-1350 rpm for a period of about 90 seconds.

It can therefore be appreciated that with respect to the mixing that may take place in the present invention, as applied to mixing EPA with toner, such mixing may efficiently take place in multiple stages in a conical mixing device, wherein the RPM₁<RPM₂ and wherein T₂>T₁, wherein RPM₁ represents the conical rotor rpm in stage 1, RPM₂ represents the conical rotor rpm in stage 2, and T₁ represents the time for mixing in stage 1 and T₂ represents the time for mixing in stage 2. In addition, the temperature of the mixing process may again be controlled within such multiple staged mixing protocol such that the heating/cooling jacket and/or the polymer within the toner (as measured by an internal temperature probe) is maintained below its glass transition temperature (Tg).

It has been found that the mixing of toner particulate with extra particulate additive in the conical mixing device according to the above provides a relatively more uniform surface distribution of EPA. Initially, toner formulations may be prepared as noted below in Table 1:

TABLE 1¹

| | XPE 2723 | | NE701/LLT113 | |
|---|---|---|---|---|
| | Conventional | | Conventional | |
| | Shape | | Shape | Rounded |
| | (Jet Milled) | Rounded Shape² | (Jet Milled) | Shape |
| HENSCHEL ® | CONTROL 1 | TONER #1 | CONTROL 1 | TONER #4 |
| FINISHING | | | | |
| CYCLOMIX ® | TONER #3 | TONER #2 | TONER #6 | TONER #5 |
| FINISHING | | | | |

¹XPE2723 is reference to a magenta color toner, polyester resin based, including recycled polyester available from Polymers Corporation. NE701/LLT113 is also reference to a magenta color toner, polyester based, containing a mixture of a lightly crosslinked polyester resin and linear polyester resin, available from Kao. Hensehel ® finishing is reference to the use of a Hensehel ® mixer, which is an example of a non-conical mixer.
²Rounded shape is reference to an initial rounding operation of toner as herein described.

The toners identified above were then evaluated for “off-line” characteristics which may be considered when attempting to identify and screen toners that may provide adequate performance within a given printer. Such characteristics are presented below in Table 2.

TABLE 2

| | XPE 2723 | | NE701/LLT113 | |
|---|---|---|---|---|
| | Conventional | | Conventional | |
| | Shape | | Shape | |
| | Jet Milled | Rounded Shape | Jet Milled | Rounded Shape |
| HENSCHEL ® | CONTROL 1 | TONER #1 | CONTROL 2 | TONER #4 |
| FINISHING | Epping Qt: −63 | Epping Qt: −34.4 | Epping Qt: −70 | Epping Qt: −58.8 |
| | Cohesion: 7 | Cohesion: 17.2 | Cohesion: 6.7 | Cohesion: 10.6 |
| CYCLOMIX ® | TONER #3 | TONER #2 | TONER #6 | TONER #5 |
| FINISHING | Epping Qt: −48.9 | Epping Qt: −37.8 | Epping Qt: −60.2 | Epping Qt: −55.3 |
| | Cohesion: 9.4 | Cohesion: 9.2 | Cohesion: 9.7 | Cohesion: 8.7 |

In Table 2, reference to the off-line characteristic of cohesion may be measured through the use of a Hosakowa Micron powder flow tester. A quantity of toner may be placed in the device which consists of a nested stack of screens resting on a stage which may then be vibrated. Upon shaking/vibrating the stage for a period of time, the amount of toner passing through the screens may be measured to assign a cohesion value. It has been demonstrated that cohesion may then provide useful information regarding toner performance in a printer. For example, relatively low cohesion (<2.0) may be difficult to contain and may leak out of bearing and seals. Relatively high cohesion (>11) tends not to respond well to mixing and paddles in the toner reservoir within a given cartridge. In addition, such toner may tend to form relatively dense clumps which may then interfere with efficient delivery of toner to a developer roller. Accordingly, it can be seen that the toner formulations herein, which rely upon the use of a conical mixer to mix toner and EPA, provide relatively higher values of cohesion as compared to a conventional Henschel type finishing process (compare cohesion values of toners 2, 3, 5 and 6 to control 1 and 2).

Furthermore, the other off-line characteristic reported in Table 2 is the Epping toner charge value (“Epping Qt”). Such value may be determined by combining toner and carrier beads of approximately 100 micron diameter, which tribocharge with one another. Accordingly, a known amount of toner and carrier beads are mixed and shaken together, and a pre-weighed sample of such toner/bead combination is placed in a Faraday cage with screens on both ends. The Epping Q meter accommodates the cage and directs air in one end of the cage. Charged toner passes with the air stream out of the other (i.e., the screen retains the beads). Weights before and after toner removal provide toner mass; an electrometer measures the toner charge (i.e., carrier charge of equal and opposite sign corresponding to the toner removed.) It should therefore be appreciated that toner charge may serve as a basis for evaluating toner conveyance in an electrophotographic system. Too low a charge represents toner which may be considered uncontrollable, and one which will not be responsive. Charges which are too excessive may cause problems as such toners may adhere relatively strongly to numerous surfaces and are therefore not amenable to development, transfer, etc., and tend to promote filming events. As can therefore be seen in the Table 2, toners 2, 3, 5 and 6, which all were exposed to the process of mixing with EPA in the conical mixer as disclosed herein, provided a relatively lower Epping Qt than control toners 1 and 2. Accordingly, toners 2, 3, 5 and 6 are not as likely to adhere to numerous surfaces, not as likely to film, and may be more amenable to development and transfer within an electrophotographic image apparatus.

In addition to the above, functional performance data for a given toner may also be evaluated. Among these, charge per mass ratio (q/m) may be understood as the charge of the toner per mass of the toner as measured on various devices within the imaging device, such as the photoconductor (PC) or developer roll (DR). For example, the value of PC q/m may be determined wherein an image of unfused powder is created (developed) on the PC drum surface. A vacuum pencil may then be employed to remove this toner from the drum surface. The charge of the toner is then accumulated as it is removed by the use of a Faraday cage pencil wherein the insulated cage accumulates the charge from the charged toner as it is collected therein. The weight before and after vacuuming determines the mass of the toner collected, as explained more fully below. An electrometer is connected to the cage to determine the charge of the toner mass removed. It is therefore desirable that the charge per mass ratio of the toner remains relative stable over the passage of time within an image forming apparatus.

As alluded to above, toner mass per unit area (m/a) may be understood as the mass of the toner per unit area as measured on various devices within the imaging device, such as the photoconductor (PC) or developer roll (DR). Again, as noted above, an image of known area (“a”) may be developed on the PC surface. Using the vacuum pencil described above, the mass of the toner removed may be determined and a value of PC m/a may be determined. It is therefore desirable that the toner mass per unit area remains relatively stable over the passage of time within an image forming apparatus.

In a non-limiting exemplary embodiment, a color toner particle (magenta) based on a mixture of polyester binder resins was finished herein in the above described conical mixer by combining such toner particles wherein mixing was carried out under conditions wherein the temperature of the toner and EPA was maintained at a temperature less than the Tg of either of the two polyester binder resins. The toner product was then life tested in an electrophotographic device with respect to the photoconductor and the results are noted below in Table 3.

TABLE 3
Test Results

| Time (hrs) | PC q/m | PC m/a |
|---|---|---|
| 0 | −19 | 0.69 |
| 10 | −20.32 | 0.68 |
| 20 | −20.13 | 0.67 |
| 30 | −19.6 | 0.67 |
| 60 | −20.8 | 0.65 |
| 120 | −17.2 | 0.67 |

As can be seen, the results confirm a relatively stable charge per mass ratio for the photoconductor wherein the value of PC q/m is maintained within about +/−5.0 units during operation over a period of 120 hours, including all values and increments therein. For example, the value of PC q/m may now be maintained within above +/−4 units, +/−3 units, +/−2.0 units, +/−1.0 unit, +/−0.50 units, etc. In a related manner, the toner mass per unit area for the photoconductor may be maintained within +/−0.20 units, including all values and increments therein. For example, the value of PC m/a may be maintained within +/−0.10 units, +/−0.05 units, +/−0.04 units, +/−0.03 units, +/−0.02 units, +/−0.01 units, etc.

In addition to the above, it should be noted that toner may be supplied herein wherein said toner may have first undergone what may be understood as a rounding operation. In such a process, toner may again serve as the starting material for the initial rounding operation. The toner is therefore placed in the conical mixing chamber and extra particulate additive (e.g., silica) may be added. The temperature of the contents may then be allowed to rise with the temperature of heat applied to the conical mixer jacket, and eventually the temperature of the mixture may be allowed to approach or exceed (e.g., by about 10-15° C.) the Tg of the polymer resin within the toner formulation. In this rounding operation the temperature may be controlled such that the particles may indeed be deformed and rounded, but not to a temperature wherein the particles may agglomerate.

Furthermore, it may be noted that in this rounding operation, the added silica may serve to prevent the particles from associating with one another and the rounding may occur due to collisions with the vessel stirring mechanism, walls and other toner particles. In addition, at the conclusion of such a rounding operation, the contents may be cooled and discharged, or subjected to the addition of extra particulate additive as noted above. In the rounding operation it may therefore be appreciated that the toner particle surface may be impregnated with the silica. Accordingly, in this rounding procedure, conventional toner may be rendered relatively more round and relatively more spherical in contour. Such rounding may be facilitated by heating at or above Tg wherein the polymer resin may be rendered relatively more malleable and the relatively rough, jagged edges of the toner particles may be made to have a relatively smoother and rounder surface.

By way of example, one may first implement the above referenced rounding operation by mixing in a conical mixer having temperature control, toner and silica particles, wherein the toner again includes polymer material having a glass transition temperature (Tg) and the mixing is carried out wherein the temperature of the device is raised to a temperature that is at or exceeds the Tg (e.g., by about 10-15° C.). This step, which may be understood as the rounding step, may then be followed by adding of extra particulate additive and mixing wherein mixing is now carried out where the temperature of the device is controlled so that the device is cooled or maintained at a temperature less than Tg. In addition, it should be appreciated once again that the temperature of the contents within the conical mixer may be directly monitored, such that the actual temperature of the contents may be regulated and heated/cooled to achieve temperatures either above or below Tg.

Moreover, in the above example, it has been found that with respect to that toner material that may have undergone a previous rounding operation, such toner may first be desirably exposed to an initial break-up of relatively loosely held agglomerates of toner. Such break-up of agglomerates may be achieved by mechanical agitation wherein the temperature of the mixer and/or contents is again maintained below the Tg of those polymer resins that may be within the toner. For example, the rounded toner may be placed in the conical mixer wherein the internal temperature probe may be set to about 25° C. and the outer heating/cooling jacket is set to about 20° C. The rotor/mixing paddles may then be rotated at about 300-350 rpm for a period of 15-25 seconds, followed by rotation at about 2000 rpm for about 90-150 seconds. At this point, the additional extra particulate additive may be added and mixing may proceed wherein, again, the temperature of the device is maintained at a temperature less than Tg of the polymer resin(s) within the toner, or the actual temperature of the contents are directly monitored and regulated to achieve a temperature below Tg.

The foregoing description is provided to illustrate and explain the present invention. However, the description hereinabove should not be considered to limit the scope of the invention set forth in the claims appended here to.

What is claimed is:

1. A method for combining extra particulate additive with toner comprising:
mixing toner and extra particulate additive to form a mixture in a conical mixer, wherein said toner comprises polymeric material having a glass transition temperature (Tg) and said mixing is carried out wherein said mixture is maintained at a temperature less than Tg.

2. The method of claim 1 wherein said mixture is maintained at a temperature about 5° C. or more below Tg.

3. The method of claim 1 wherein said toner comprises a plurality of polymer materials each having a Tg including a lowest relative Tg wherein said mixture is maintained at a temperature that is lower than said lowest relative Tg.

4. The method of claim 1 wherein said conical mixer includes a rotor and one or more mixing paddles which may be controlled to a selected rpm (RPM) value for a selected time (T).

5. The method of claim 4 wherein said mixing is carried out in a plurality of stages, each stage having a selected RPM value and time T for mixing.

6. The method of claim 5, wherein
RPM₁<RPM₂
and T₂>T₁
wherein RPM₁ represents a conical rotor rpm in stage 1, RPM₂ represents a conical rotor rpm in stage 2, T₁ represents the time for mixing in stage 1 and T₂ represents the time for mixing in stage 2.

7. The method of claim 1 wherein said extra particulate additive is present at a level of less than about 5.0% (wt.) within said toner.

8. A method for combining extra particulate additive with toner comprising:
mixing in a conical mixer toner and extra particulate additive to form a mixture, wherein said toner comprises polymer material having a glass transition temperature (Tg) and said mixing is carried out wherein said mixture is raised to a temperature that is equal to or exceeds said Tg; and
adding additional extra particulate additive and mixing wherein said mixture is maintained at a temperature less than Tg.

9. The method of claim 8 wherein, prior to addition of said additional extra particulate additive, said toner is mechanically agitated.

10. The method of claim 8 wherein said step of adding additional extra particulate additive and mixing is carried out wherein the mixture is maintained at a temperature about 5° C. or more below Tg.

11. The method of claim 8 wherein said conical mixer includes a rotor and one or more mixing paddles which may be controlled to a selected rpm (RPM) value for a selected time (T).

12. The method of claim 11 wherein said step of adding additional extra particulate additive and mixing is carried out in a plurality of stages, each stage having a selected RPM value and time T for mixing.

13. The method of claim 11 wherein said step of mixing toner and extra particulate additive under conditions wherein mixing is carried out wherein the temperature is raised to a temperature that exceeds Tg, is carried out in stages, each stage having a selected RPM value and time T for mixing.

14. The method of claim 12, wherein:
RPM₁<RPM₂ and
T₂>T₁
wherein RPM₁ represents a conical rotor rpm in stage 1, RPM₂ represents a conical rotor rpm in stage 2, T₁ represents the time for mixing in stage 1 and T₂ represents the time for mixing in stage 2.

15. The method of claim 13, wherein:
RPM₁<RPM₂ and
T₂>T₁
wherein RPM₁ represents a conical rotor rpm in stage 1, RPM₂ represents a conical rotor rpm in stage 2, T₁ represents the time for mixing in stage 1 and T₂ represents the time for mixing in stage 2.

16. The method of claim 8 wherein said step of adding additional extra particulate additive comprises adding to a level of less than about 5.0% (wt.) within said toner.
